(19) United States
(12) Patent Application Publication
(10) Pub. No.: US 2008/0132279 A1
(43) Pub. Date: Jun. 5, 2008

(54) UNLICENSED MOBILE ACCESS

(76) Inventor: Steven H. Blumenthal, Lexington, MA (US)

Correspondence Address: OCCHIUTI ROHLICEK & TSAO, LLP, 10 FAWCETT STREET, CAMBRIDGE, MA, 02138, US

(21) Appl. No.: 11/566,616

(22) Filed: Dec. 4, 2006

(51) Int. Cl. H04B 1/38

(52) U.S. Cl. 455/558

(57) ABSTRACT

An apparatus, such as a removable computer device (e.g., a USB device), includes application software stored on a computer-readable medium which may be loaded to computer coupled to the device. An interface on the device is used to couple the apparatus to a computer and to pass the application software to the computer. The application software can include a “soft phone” application. An authentication module on the device provides authentication information, for example from a Subscriber Identification Module (SIM) through the interface, and the application software includes instructions for using the authentication information in a communication exchange over a data network using a cellular telephone protocol with a network element coupled to a cellular telephone network. In some examples, the protocol is a GSM protocol and the network element is Unlicensed Mobile Access (UMA) Network Controller (NC).

### CROSS-REFERENCE TO RELATED APPLICATIONS

This application is related to U.S. application Ser. No. 11/397,313, filed Apr. 3, 2006, and titled “NETWORK BASED AUTHENTICATION,” and related to PCT Application PCT/US2005/025353 designating the United States, titled “PRESENCE DETECTION AND HANDOFF FOR CELLULAR AND INTERNET PROTOCOL TELEPHONY”, and published on Feb. 23, 2006, as WO 2006/020168A2. The contents of these applications are incorporated here by reference.

### BACKGROUND

This document relates to network based authentication.

GSM cellular telephone systems, for example, use a subscriber identification module (SIM) in a user's mobile phone (MS, Mobile Station) for authentication prior to establishing a telephone call with the MS. In one approach, an HLR (Home Location Register) in conjunction with an AuC (Authentication Center) shared secret authentication data (e.g., a secret key Ki) with the SIM for each user that is registered in the HLR.

The SIM is designed not to disclose the secret authentication data, and the AuC/HLR also protects that data. When authentication for a call is needed, the MSC (Mobile Switching Center) of the network that is handling the MS requests data from the AuC/HLR, this data is commonly referred to as a “triplet,” consisting of RAND, SRES, and Kc. The RAND is a random number, which in combination with Ki the secret authentication data known to the SIM in the MS can generate SRES (signed response) and Kc (confidentiality key). The MSC passes RAND to the MS, which uses the SIM card's cryptographic processing of RAND to generate SRES and Kc. The MS sends SRES back to the MSC. The MSC compares the value of SRES it received from the AuC/HLR and the value it received from the MS, and if it they match, it treats the MS as authenticated. The MSC and MS then communicate securely based on the session key Kc they now know they share. In GSM networks, Kc is sent from MSC to Base Transceiver Station to be able to encrypt/decrypt the over-the-air channel.

The SIM is typically implemented as a removable card that can be moved from phone to phone when a user changes phones. The SIM card can include storage for data that is personal to the user, including for example, a dialing directory, call logs, and text or voice messages.

SIM functions have been integrated into computer-based devices, for example, for use for secure commercial transactions. For example, a commerce server may authenticate a credit card in an exchange that is similar to that used in a GSM network.

SIM functions have also been used for access control for wireless networks, in which an authentication server for the wireless network, for example, a server that interacts with the wireless devices using the RADIUS protocol, communicates with the HLR/AuC function of a wireless telephone network to receive a (RAND, SRES, Kc) triplet that the authentication server uses to determine whether to provide network access to the wireless device. In some such approaches, EAP (Extensible Authentication Protocol)—SIM and 802.1x protocols are used between the wireless device and the authentication server. The SIM function in such approaches can be integrated into a USB or PCMCIA card for insertion into a computer that seeks to be authenticated to access a wireless network.

Unlicensed Mobile Access (UMA) services allow mobile networks to extend over WiFi networks using dual-mode phones that operate on GSM radio networks or on the WiFi network. When operating on the GSM radio network, a dual-mode UMA phone acts like a regular GSM mobile phone. When operating on a WiFi network, the UMA dual-mode phone passes GSM radio link protocols over an IP-based communication tunnel to a device called a UMA Network Controller (UNC), which is part of a wireless telephone network. The UNC acts like a mobile Base Station Controller (BSC) from the point of view of the wireless network and interconnects with a Mobile Switching Center (MSC) for voice calls and SMS messaging. At the MSC level, the dual-mode UMA handset looks like a regular mobile device in either mode of operation. In-process calls can be handed off from the mobile network to the WiFi network using standard BSC to BSC or MSC to MSC handoff procedures. For data applications, the UNC connects into the mobile network's Serving GPRS Support Node (SGSN) and then into mobile network data services. Further information regarding UMA can be found in UMA Architecture (Stage 2) R1.0.4 (2005-5-2) Technical Specification.

### SUMMARY

In one aspect, in general, application layer authentication of a data-network based application that is remote to a server makes use of a SIM function accessible to the application and telephone network authentication service accessible to the server. In some examples, the application uses SIP (Session Initiation Protocol) for communication with the server and the authentication service is provided via a GSM based telephone network.

In another aspect, in general, an apparatus includes an authentication module, application software, and an interface for communicating with a remote server over a data communication network. The application software includes instructions for using the authentication module to authorize an application layer interaction with the remote server.

In another aspect, in general, an apparatus includes application software stored on a computer-readable medium, an interface for coupling the apparatus to a computer and for passing the application software to the computer, and an authentication module for providing authentication information through the interface. The application software includes instructions for using the authentication information in a communication exchange over a data network using a cellular telephone protocol with a network element coupled to a cellular telephone network.

In another aspect, in general, a method for providing telecommunication services includes executing a telecommunication application on a general purpose computer. During execution of the communication application authentication information is used at the computer in a communication exchange over a data network using a cellular telephone protocol with a network element coupled to a cellular telephone network.

One or more of the following features may be included.

The apparatus includes a removable device for repeated coupling to the computer. For example, the device includes a Universal Serial Bus (USB) interface.

The telecommunication application is loaded from a removable device coupled to the computer.

The authentication information is accessed from the removable device.

The cellular telephone protocol includes a GSM protocol.

The network element includes an Unlicensed Mobile Access (UMA) network controller.

The cellular telephone protocol includes an IS-41 protocol.

The authentication module includes an interface for a Subscriber Identification Module (SIM) for accessing the authentication information. Using the authentication information can include accessing the authentication information from a Subscriber Identification Module (SIM).

The apparatus includes a secure storage for information for related to interaction with the cellular telephone network.

The secure storage includes storage for cryptographic information and/or software.

The cryptographic information and/or software includes at least one of the USIM, ISIM, CAVE, and IPsec information and/or software.

The application software is for execution on the computer system.

The application software includes instructions for a communication application. For example, the communication application comprises a softphone application. The communication application can include a configurable user interface for emulating one of a plurality of mobile telephone devices.

The authentication module includes a module compatible with authentication in a mobile telephone network. For example, the authentication module includes at least one of a Subscriber Identification Module (SIM), a Universal Subscriber Identity Module (USIM), a 3GPP IP Multimedia Subsystem Services Identity Module (ISIM), and a module compatible with a CDMA or 3GPP2 networks.

The application layer interaction includes a voice communication interaction.

The application layer interaction includes a registration interaction. For example, the registration interaction includes a Session Initiation Protocol (SIP) interaction.

The instructions for using the authentication module to authorize the application layer interaction include instructions that cause authentication via a telephone network authentication system.

The apparatus further includes a positioning system. For example, the positioning system includes a Global Positioning System (GPS).

The application software includes instructions for accessing the positioning system and providing location information over the data communication network.

In another aspect, executable software is loaded from a removable device. The software is executed. This execution includes accessing an authentication module on the removable device, communicating with a remote server over a data communication network, and using the authentication module to authorize an application layer interaction with the remote server.

One or more of the following features may be included:

Executing of the software is performed on a mobile computer system to which the removable device is attached.

The removable device is attached to the computer system.

Executing of the software includes executing a communication application. For example, the communication application includes a softphone application.

In another aspect, in general, an application layer request is received from a client over a data communication network. An authentication exchange is performed for the client with an authentication service over a telecommunication network. This exchange includes receiving authentication data for the client. The authentication data is used to perform an authentication exchange with the client over the data communication network.

One or more of the following features may be included.

Receiving the application layer request includes receiving a session initiation request. For example, receiving the session initiation request includes receiving a Session Initiation Protocol (SIP) registration request.

Performing the authentication exchange over the telecommunication network includes emulating an authentication exchange for a mobile station accessing the telecommunication network.

After performing the authentication exchange with the client, communication services are provided for the client via the data communication network and the telecommunication network.

In another aspect, in general, a content request is received at a content distributor from a client device over a data communication network. An authentication exchange is performed for the client device between the content distributor and an authentication service. This exchange includes receiving authentication data for the client device at the content distributor. The authentication data is used to securely distribute content to the client device.

One or more of the following features may be included.

Securely distributing the content to the client device includes performing encryption based on secret information shared between the authentication service and the client device. For example, the secret information shared between the authentication service and the client device includes information stored on an authentication module at the client device. The authentication module may include at least one of a Subscriber Identification Module (SIM), a Universal Subscriber Identity Module (USIM), a 3GPP IP Multimedia Subsystem Services Identity Module (ISIM), and a module compatible with a CDMA or 3GPP2 networks.

The authentication service is associated with at least one of a manufacturer of the client device, a mobile network operator, a credit card company, a computer or software company, and a media seller.

In another aspect, in general, a rights management system includes one or more authentication centers, and a set of content distributors in communication with the authentication centers, with least some of the content distributors being in communication with a common one of the authentication centers. Multiple client devices are each configured to securely receive content from one or more of the content distributors and each include an authentication module for use in authenticating the client device to the content distributors. Each content distributor is configured to authenticate a client device using one of the authentication centers and an authentication exchange with the client device, and to cryptographically secure content for sending to the client device such that the secured content is accessible using the authentication module at that client. The authentication module at the client device includes, for example, at least one of a Subscriber Identification Module (SIM), a Universal Subscriber Identity Module (USIM), a 3GPP IP Multimedia Subsystem Services Identity Module (ISIM), and a module compatible with a CDMA or 3GPP2 networks.

Implementations can have one or more of the following advantages.

Authentication of application-layer communication using a SIM allows network connectivity to be controlled separately, and possibly using different mechanisms, from control of access to application functions.

Using a SIM for repeated generation of new keys to protect a media stream can provide better security compared with using a single key for an entire session. For example, a secure VoIP call can make use of frequent changes in SIM generated key used to protect SIP signaling and/or an RTP data stream.

No modification of a local area network infrastructure is necessarily needed to support application layer authentication. For example, a wireless device can join a wireless LAN, for example, in a public place and separately establish authenticated communication through a wireless communication network without requiring any device, such as a proxy authentication service, to be present on the local network.

Use of a UMA based access approach allows a computer to access a cellular telephone network without modification of network elements in the cellular network.

A user can have a personal dongle that holds both a communication application and a SIM function, thereby allowing the user to establish secure communication from a computer that does not have preexisting support for such communication. For example, a user may have access to a networked computer, and by inserting such a USB dongle, execute an application stored on the dongle and authenticate the application using the SIM function on the dongle, even though the computer does not have any particular support for the application or authentication approach.

A standard SIM used configured for access using a UMA compatible dual-mode telephone can be used in a USB device that permits softphone access to the UMA based network from a computer.

An open rights management system can be established in which authentication centers are separate from content distributors. For example, each content presentation device (e.g., a music player) can be associated with a corresponding authentication center. When a content distributor needs to authenticate a presentation device, it uses an appropriate authentication center for the device. In this way, a user of a content presentation device is not tied to any one particular content distributor, as long as the content distributor they use is able to use the appropriate authentication center.

Other features and advantages will become apparent from the following description and from the claims.

### DESCRIPTION OF DRAWINGS

FIG. 1 is a dongle for use with a computer, for example, via a USB (Universal Serial Bus) interface.

FIG. 2 is a client computer coupled to a wireless access point, which provides network connectivity to the client computer.

FIG. 3 is a computer and communication network system.

FIG. 4 is diagram that illustrates interactions between elements of the system.

FIG. 5 is a media player.

FIG. 6 is a network coupling a media player to media distributors.

FIG. 7 is a diagram that illustrates an Unlicensed Mobile Access (UMA) based system.

### DESCRIPTION

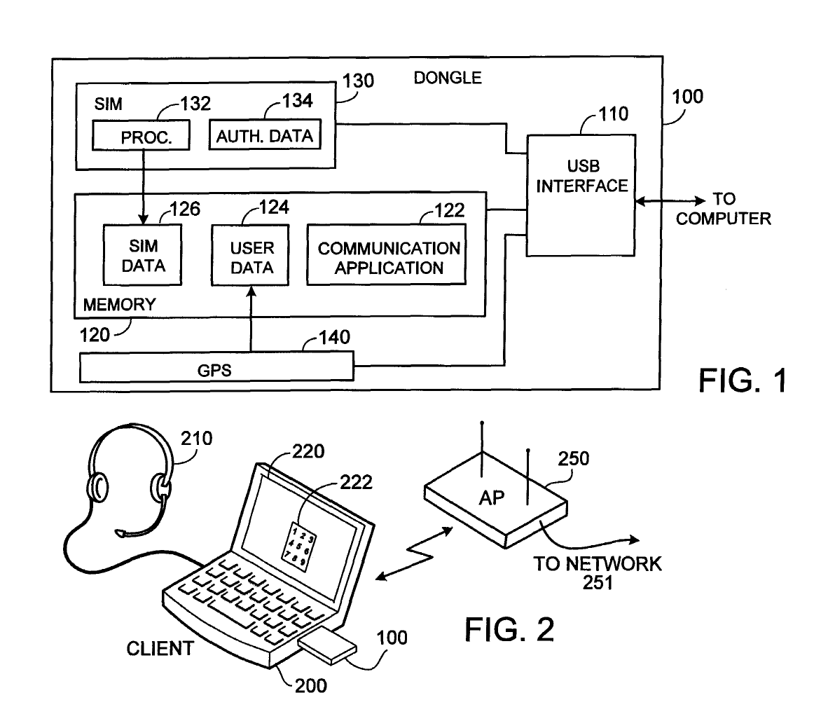

Referring to FIG. 1, a “dongle” 100 is configured to be used with a client computer 200 (see FIG. 2), such as a laptop personal computer. (A “dongle” typically includes a security or authentication device that is configured to be plugged into a port of, or otherwise connected to, another device, such as a computer, to enable particular functions on that device). In this example, the dongle 100 uses a USB (universal serial bus) 110 interface for communication with the computer. The USB interface 110 provides electrical and signal protocol support that allows the computer to communicate with and access functions on the dongle. For example, the USB interface 110 presents a storage device (e.g., disk drive) interface to the computer allowing the computer to access a non-volatile memory 120 (e.g., a flash memory) on the dongle 100, for example, formatted according to a disk format (e.g., with files, directories, etc.). The USB interface 110 also presents a SIM device interface to a SIM 130 that is integrated into the dongle (or alternatively, removably inserted as a separate SIM card that is used in the dongle). The SIM device interface provides functionality, including, for example, a mechanism for providing a RAND from the computer, and for passing back to the computer a derived SRES and Kc that is computed in a processor 132 in the SIM and that depends on the RAND and secret authentication data 134 in the SIM 130.

The memory 120 on the dongle 100 includes an application 122, which can be executed on the computer to which the dongle is attached. For example, the application can include one or more files that include executable instructions (e.g., .exe and .dll files for execution under a version of the Microsoft Windows operating system) as well as configuration files that are used by the executing application. The application can alternatively or additionally include versions suitable for other operating systems (e.g., Apple Mac OS X) or other operating environments (e.g., a JAVA Virtual Machine).

The memory 120 can also store user data 124, which is specific to the user. For example, such data can include the user's address book and/or information related to the communication application. The memory 120 can also store SIM data 126, which is accessed by the SIM, or alternatively, such SIM data may be held within the SIM, for example, in the case that the SIM is a removable card.

In some examples, the dongle 100 also includes a GPS receiver 140, which can determine a geographic location of the dongle. In some examples, the location information is stored in the user data 124 and later accessed through the USB interface 110, which can be accessed via the USB interface 110. In some examples, the location information in the GPS received 140 is accessed directly through the USB interface 110.

Referring to FIG. 2, the client computer 200 has established wireless communication via a wireless access point 250 to a network 251. For example, the access point 250 couples the computer to a local area network, which provides the computer with an Internet Protocol host address (for example, using a DHCP (Dynamic Host Configuration Protocol) server on the LAN) and which provides a gateway to a wide area IP network, such as a gateway to the public Internet. The local network does not necessarily have to be configured specifically to take advantages of functionality provided by the dongle. For example, the local network may be at an Internet “hotspot” or “cafe” that provides free or pay public access to the Internet.

In some examples, the communication application 122 (see FIG. 1) that is stored on the dongle 100 is a voice-over-IP communication application (e.g., a “softphone”). In such an example, a user inserts the dongle 100 into the client computer 200. The user has access to the memory 120 of the dongle and executes the communication application, for example, by manually navigating the file system represented in the memory. Alternatively, the communication application “auto-executes” as a result of the operating system detecting insertion of the dongle into the USB interface of the computer 200.

The executing communication application presents a user interface 222 (for example, showing a telephone dialing keypad) on a display 220 of the computer. The computer also has an audio input/output device 210 that is coupled to the executing application, for example, to provide a speech input/output interface for the user of the application. In some examples, a softphone application is configurable so that the user interface matches a physical mobile telephone model (e.g., another phone owned by the user of the application).

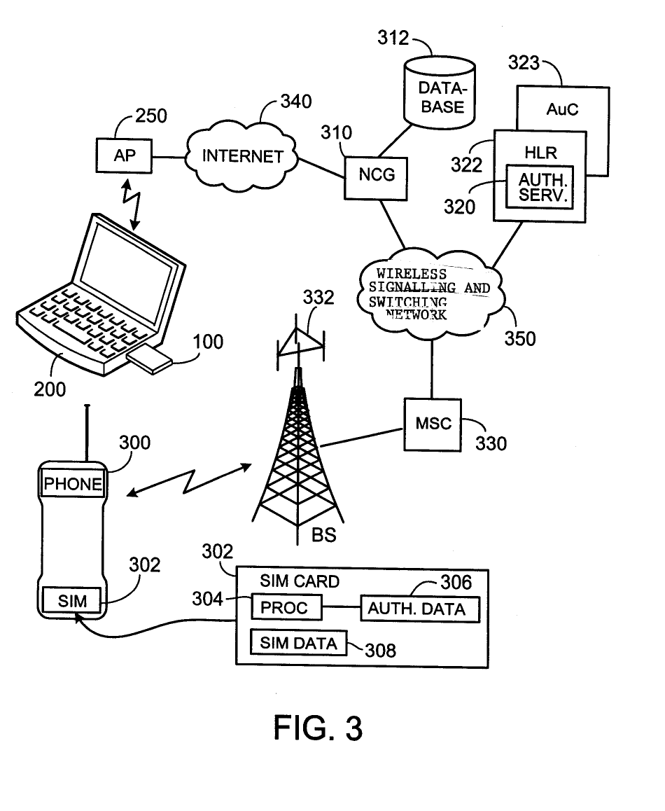

Referring to FIG. 3, to initiate or receive calls, the communication application executing on the client computer 200 registers with a gateway (NCG) 310, which is coupled to both the Internet 340 for communication with the computer 200 via the wireless access point 250, and is also coupled to a wireless signaling and switching network 350 for communication with functions in the wireless network. In this example, the gateway 310 communicates with the network elements using standard GSM/MAP/SS7 protocols. An authentication service 320, in this example provided by a HLR (Home Location Register) 322 in conjunction with an AuC (Authentication Center) 323, is coupled to the network 350.

In an approach described in the PCT Application “PRESENCE DETECTION AND HANDOFF FOR CELLULAR AND INTERNET PROTOCOL TELEPHONY,” which is incorporated by reference, the gateway 310, which is also referred to as a “Network Convergence Gateway (NCG)”, enables a VoIP application running on the computer 200 to make and receive calls using the SIP protocol between the application and the gateway 310, while the gateway uses wireless network techniques to make and maintain the calls in the wireless network.

Before continuing with the description of functions involving the NCG 310, conventional authentication of a mobile station (MS) 300 (e.g., a phone) is described. When the MS 300 needs to be authenticated by the MSC (Mobile Switching Center) 330 that is providing connectivity between the MS and the wireless network via a BS (Base Station), the MSC receives identifying information for the MS, typically the IMSI (International Mobile Subscriber Identifier) for the phone. The MSC sends the IMSI to the authentication service 320, which returns the (RAND, SRES, Kc) triplet to the MSC 330. The MSC sends the RAND to the phone 330, which passes the RAND to the SIM card 302 in the phone. The SIM card 302 returns the SRES and Kc to the phone, which forwards only the SRES back to the MSC. The MSC authenticates the phone if the SRES from the authentication service and from the phone match.

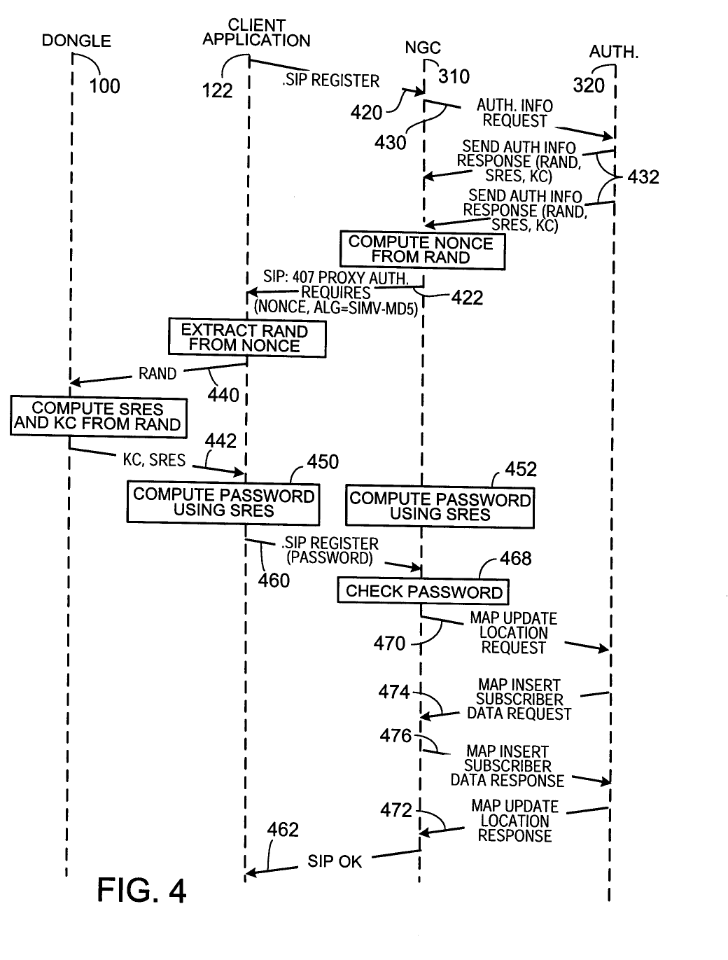

Referring to FIG. 4, in the case of a communication application 122 executing on the client computer 200, a related sequence of exchanges is performed (reference numerals in parentheses below indicate messages or steps illustrated in FIG. 4). Note that in FIG. 4, the client computer already has network connectivity over the Internet and can access the NCG 310 using standard IP- and UDP/TCP-based communication. As an initial step of execution of the communication application, the application sends a request to the dongle 100 to read the identity of the NCG server 310 with which it should register, and the dongle 100 returns a SIP identity where the application should register, for example, as IMSI@nomadic.com. The communication application 122 then sends a SIP registration message to the NCG 310 (420) that includes the SIP identity. The NCG determines that SIM-based authentication is required, for example, because it is required for all SIP registrations, or based on configuration data that identifies that such authentication is required for this client. Using the same protocols as used between the MSC 330 (see FIG. 3) and the authentication service 320, the NCG 310 sends the IMSI for the SIM to the authentication service 320 (430) and in return, the authentication service returns a (RAND, SRES, Kc) triplet (432). Multiple triples may be returned in multiple messages 432, for example, if longer or additional keys Kc are needed. The NCG replies (422) to the registration request with a “407 unauthorized, authentication required” SIP message to the communication application.

The reply 422 from the NCG 310 to the communication application 122 includes the RAND, an identifier of the hash algorithm (e.g., SIMv1-MD5) to apply to the data in the next registration request, and a Nonce that depends on RAND and server-specific information. The communication application 122 receives the reply (422), extracts the RAND from the Nonce, and passes the RAND to the dongle 100 (440). In return, the dongle returns the SRES and Kc (442) to the communication application 122. The communication application (122) uses the SRES to computes the password for the new registration request (450). The NCG similarly computes the hash (452) using the same value of SRES. The communication application 122 sends a SIP registration request (460), including the computed password to the NCG. The NCG compares the passwords (468), and if they match, authenticates the communication application. The NCG 310 sends a location update request (470) via SS7 to the HLR, which causes phone calls to the user to be delivered through the NCG. The HLR may request subscriber data (474) which the NCG provides in return (476). The HLR confirms the location update (472). At that point, the NCG responds (462) to the SIP registration request with an OK message.

At this point, the NCG 310 and the communication application 122 share knowledge of a session key Kc, which was computed from the RAND provided by the AuC/HLR. This key is optionally used to encrypt communication between the communication application and the NCG. For example, when a VoIP call is established with a RTP (Real-Time Protocol) media session between the communication application and a media server at the NCG, the session key Kc is optionally used to protect the data. The same Kc can be used for the life of the registration of the communication application with the NCG. The NCG can periodically challenge the communication application with a new RAND received (as part of a triplet) from the authentication service 320, and with the response to each challenge, the communication application and the NCG update the key. Therefore, the same key does not have to be used for an extended period. Even within an active VoIP call, the value of Kc protecting the RTP data stream and be changed, for example, once every minute, providing increased cryptographic protection as compared, to using the same value of Kc for the duration of a call.

The SIP/SIM based authentication described above is at the application layer (i.e. ISO layer 5 or above) rather than at a data link or network/transport layer and is in addition to and/or separate from authentication used to establish network connectivity for the client computer on the wireless LAN via the access point 250.

In some examples of this approach, the SIM is not integrated in a dongle 100. For example, the SIM function may be built into a computer as part of its motherboard or in a socket that receives a standard SIM card. Similarly, a VoIP phone, which connects directly to an Ethernet may have the SIM built in or a SIM card plugged into a socket. In each of these examples, the communication between the device and the NCG follows the approach described above with reference to FIG. 4. Similarly, a dual-mode telephone than can operate on the cellular radio network as well as on a wireless LAN can host a SIP-based communication application that communicates with the NCG as described above.

In examples in which the dongle 100 includes a GPS receiver 140, location data can be provided to the NCG 310, for example, as part of the SIP registration, and in turn provided to the HLR or other network elements. This location information can be used, for example, for emergency calls (e911 calls) to determine the location of the calling telephone. In examples where GPS reception is not available at the location where the application is executing, the GPS receiver 140 may store the last known location in the user data 124 of the dongle, and the last known location can be provided to the network elements.

Referring back to FIG. 3, the NCG can provide additional services related to a user's personal data. In FIG. 3, the user may have a phone 300 as well as a personal computer 200, both of which may have personal data such as a contact (dialing directory) database, call logs, and voice and text messages. On the phone, this data would typically be stored in SIM data 308 on the SIM card. On the computer, this data may be stored on the dongle 100, or may be stored in memory on the computer itself. The NCG, or another server, provides a way for synchronizing this user data using a centralized storage (database is not needed and storage is more general term) 312. For example, the phone 300 may communicate with the NCG using IP-based communication (e.g., using a GPRS protocol) to synchronize its data with the database. Similarly, the client computer 200 communicates using IP with the database. SIM-based authentication of the type described above may be used to protect the data. As an alternative, the phone 300 communicates using SMS, USSD or other circuit-switched or mobile packet switched techniques to synchronize its data with the database.

The approach described above can also be used for applications other than communication applications. For example, the dongle may have an application that requires authentication but might not otherwise interact with the NCG. The application may communicate with the NCG for authentication and generation of the shared secret Kc, but then the application may go on to interact with another server. The NCG shares the Kc with that other server both as a mechanism for introducing the client application to the server and to provide a way for the client and server to communicate securely. In the case of the server performing commercial transactions for the client, the server may communicate with the NCG, which provides a gateway to charging services in the wireless network. For example, a commercial transaction between the client application and the server may be charged to the user's wireless account.

In some examples, the user device that includes the SIM functionality is not necessarily a telephone or a computer. For example, the device may be a networked game console, which uses the NCG for authentication and possibly charging services via the wireless network. In the case of the game console, a dongle may be used. In this way, a game can be distributed along with the dongle for use on a networked game console without requiring modification of the game console to incorporate SIM functionality.

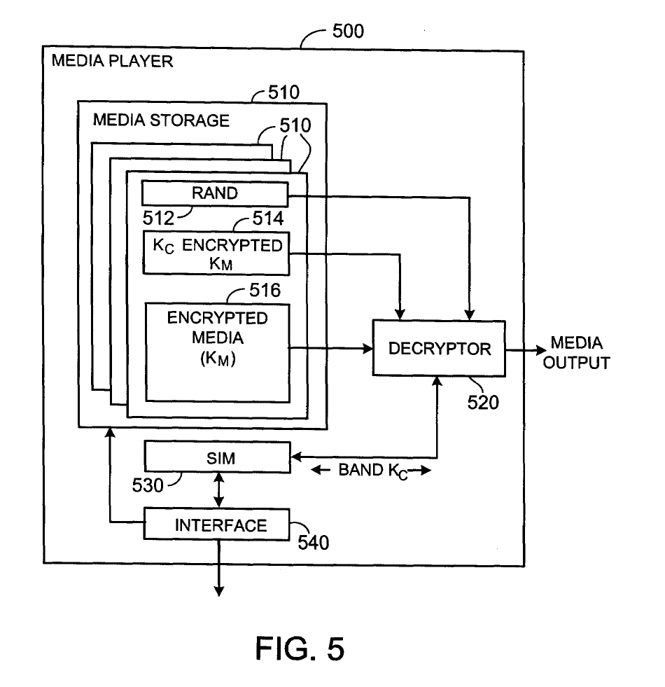

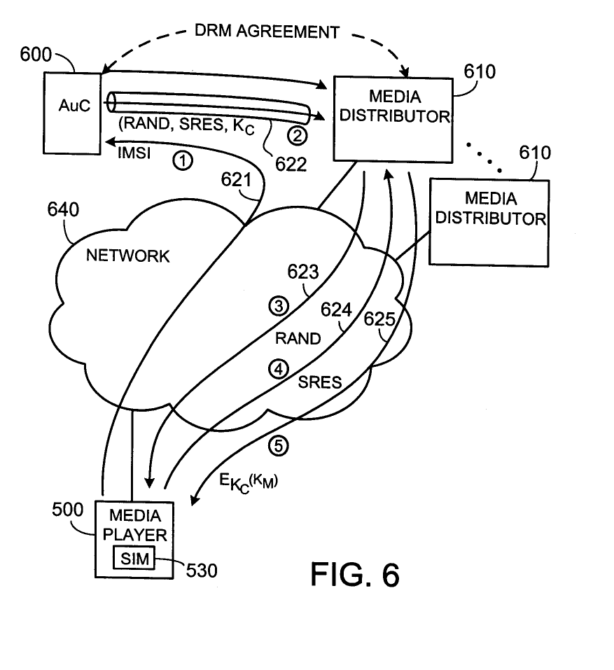

In some examples the user device uses the SIM for digital rights management (DRM), for example, in addition to using the SIM for authentication and/or changing purposes. Referring to FIGS. 5 and 6, in some examples, a media player 500 includes a SIM 530. A media distributor 610 provides protected media to the media player over a network 640 (e.g., over the Internet, or over a telecommunication network) in such a way that the player cannot make use of the media unless it has an appropriate SIM, and such that the protected data cannot be used in other media players with different SIMs.

Referring to FIG. 5, the media player 500 has an interface 540 that provides a way for a the media distributor 610 to challenge the SIM 530, for example, in the manner described above in the context of a communication application, for the purpose of authenticating the media player. In addition, the media distributor 610 may independently use the functionality of the SIM to protect media that is distributed to the player.

In some examples, each media player 500 has a SIM 530 that shares a secret (Ki) with an Authentication Center (AuC) 600. In various examples, the AuC 600 is associated with a manufacturer of the media player 500, with a computer or software manufacturer, a media seller or distributor (e.g., an online music store), a credit card company, and a mobile network operator (e.g., the AuC 600 can be the same AuC 323 as shown in FIG. 3 in the context of a communication application).

In some examples, a series of interchanges occur between the media player 500, a media distributor 610, and the authentication center 600. Note that there may be multiple AuCs 600, for example, each associated with a different set of media players or associated with different SIMs used in the media players. There are, in general, multiple media distributors 610, and in some examples, each can make use of multiple different AuCs 600.

Referring to FIG. 6, a media player provides an identification, such as an IMSI stored in the SIM, to the media distributor 610. In the case of multiple AuCs 600, the media distributor 610 uses the identification to determine which AuC 600 will provide authentication data for the media player. The media distributor 610 passes the identifying information for the media player to the AuC 600. The AuC 600 and the media distributor 610 have a commercial DRM agreement in place which governs the terms under which the AuC will provide information to the distributor. If the AuC chooses to provide authentication information to the distributor, it uses the value of Ki it knows in association with the identifying information to generate a (RAND, SRES, Kc) triplet, which it passes back to the media distributor. To authenticate the media player, the media distributor sends RAND to the media player, which computes and returns SRES. If the SRES from the media player and the SRES from the AuC match, the media player is authenticated.

The media distributor 610 sends a bundle 510 that includes encrypted media 516 that is encrypted with a media key Km that is specific to the media in that bundle but not necessarily specific to the player or the user. The bundle 510 also includes a RAND value 512, and an encryption of the media key Km 514, which is encrypted with the SIM-generated key Kc that corresponds to the RAND 512.

When the player 500 needs to play the media, a decryptor 520 accepts the RAND 512 and the Kc-encrypted Km 514, and obtains Kc from the SIM 530 in exchange for the RAND. It uses Kc to decrypt Km, which it uses in turn to decrypt the media.

In some examples of similar DRM applications, some of the functions of the server application can be performed at a client computer, for example, coupled to the player 500. For example, the player 500 may have a USB interface to a client computer, and an application on the client computer uses the SIM 530 in the player for authentication of the application.

The approaches described above can alternatively use Universal Subscriber Identity Modules (USIM) or 3GPP IP Multimedia Subsystem Services Identity Modules (ISIM). In other examples, IS-41/SS7 or 3GPP2 protocols are used for similar approaches in CMDA or 3GPP2 networks. In some examples, use of a standard SIM, USIM, or ISIM is not necessarily required. For example, other cryptographic approaches can achieve similar results. In some examples, other cellular authentication protocols may be used, for example, using the Authentication and Key Agreement (AKA) protocol rather than current protocols based on the SIM. Similarly, the cellular telephone network is not necessarily a GSM based network. In some examples, similar cryptographic authentication mechanisms for CDMA and 3GPP2 networks are used. In some examples, a CMDA/CAVE protocol is used.

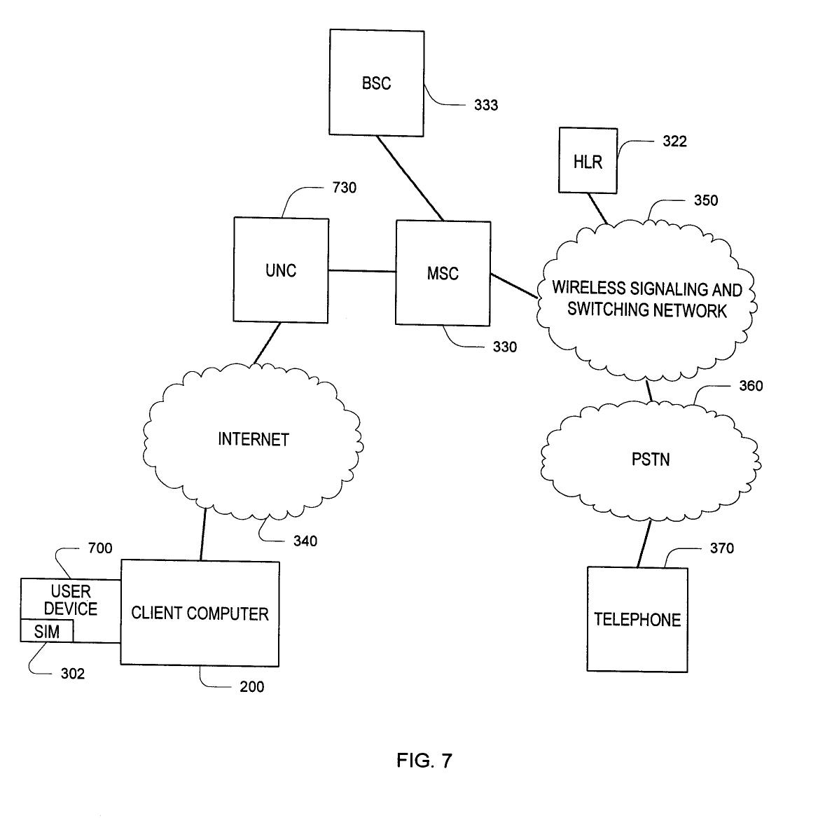

Referring to FIG. 7, a user device 700, which is similar to user device 100 illustrated in FIGS. 1 and 2, includes a communication application that is configured to communicate with a UMA Network Controller using GSM protocols that pass between a client computer hosting the device and the UMA Network Controller (UNC) 730 in IP-based tunnels over the public internet 340 or some other public or private IP network. From the point of view of the UNC, the client computer 220 interacts with the UNC as would a standard dual mode UMA telephone. That is, the function of a UMA dual mode phone is replaced with a voice over IP (VoIP) Soft Phone application that executed on the personal computer 200. This VoIP soft phone can operate from the attached user device 700, such as a USB device. Alternatively, the soft phone can be downloaded to the computer. As in earlier described examples, the user device has an interface for a GSM SIM module that is used for authentication and security. In these examples, the SIM is used as part of the GSM protocols used to communicate between the soft phone application and the UNC or other elements of the wireless network.

In some examples, the UMA based authentication is used for applications other than a soft phone application, and which may be stored on the removable user device 700. Such applications can take advantage of the authentication mechanism and security provided by the SIM module on the user device.

In some examples, the user device 700 is a USB device that contains both flash memory and a GSM SIM module that has software stored on it to run a VoIP Soft Phone that can connect to a mobile network as a mobile device. In particular, the VoIP Soft Phone uses the Unlicensed Mobile Access (UMA) protocols to connect into the mobile network via a UMA Network Controller (UNC) 730. This VoIP Soft Phone tunnels GSM radio link protocols over IP to get across the Internet 340 or some other IP network to reach the UNC 730. The UNC strips the GSM radio protocol signals out of the IP stream and interfaces to a mobile network Mobile Switching Center (MSC) 330 with the UNC acting as a Base Station Controller (BSC). The computer 200 and USB device 700 are interfaced to the mobile network via tunneling the GSM radio network protocols over the Internet ort an IP network to get to the UNC.

When the USB device 700 is plugged into the computer 200, it causes the VoIP Soft Phone to execute on the computer. The VoIP Soft Phone attaches to the mobile network by connecting to a UNC over the IP network, and then register with the HLR 332. It then performs a SIM authentication between the SIM module in the USB device and the mobile network HLR/AuC, using the standard SIM authentication algorithm for GSM. This effectively registers and authenticates the user on a computer-based VoIP soft phone to the mobile network as if they were connected to the mobile network as a regular mobile phone. If the HLR in the mobile network supports multiple profiles, i.e., multiple IMSIs for the same MSISDN (phone number), the VoIP Soft Phone can act as the user's mobile phone and have calls to their mobile number directed to the Soft Phone, when the Soft Phone is registered and authenticated by the HLR. When the VoIP Soft Phone is not registered with the HLR, the calls go to the user's mobile phone or to their voice mail account.

The SIM module contains cryptographic key material that can be used to encrypt the data and VoIP packets that go between the PC and the UNC. An alternative approach is to have the USB Device contain the software for an IPsec VPN connection and use the IPsec keys and encryption methods to protect the data and VoIP packets between the PC and the UNC.

The VoIP Soft Phone application can originate and receive Short Message Service (SMS) text messages or Multimedia Messaging (MMS) (pictures, audio files, ring tones, vide clips, streaming video, etc. from the mobile network Short Message Service Center (SMSC) or Multimedia Message Center (MMSC).

In some examples, the SIM module in the USB device could contain the USIM or ISIM authentication and encryption algorithms and keys and authenticate the computer with the USB device to a UMTS HLR/AuC or an IMS Home Subscriber Server (HSS). The USIM or ISIM can also be used to generate encrypted traffic between the computer and the UNC, or the USB Device can contain software for an IPsec VPN client and can use the IPsec encryption methods to protect the data and VoIP packets between the computer and the UNC.

For additional security, sensitive data, such as cryptographic information or software including the IPsec code and any digital certificates that are assigned to the device, in a secure storage on the device, such as can be stored in the tamper-proof protected memory of the SIM module. In addition, the protected SIM memory can store the GSM radio resource layer and GSM or CDMA radio channel access protocols to prevent them from being accessible to the user.

In some examples, the SIM module in the USB device is used to implement the CDMA network CAVE authentication and encryption algorithm In such cases, the UNC can implement the CDMA network radio channel protocols tunneled over IP, and would connect into a CDMA MSC. The CDMA MSC would use the CDMA IS-41 mobile network signaling protocols over SS7 to connect to the CDMA HLR/AuC, SMSC, MMSC, and voice mail servers. The SIM can also be used to generate encrypted traffic between the PC and the UNC according the CDMA CAVE algorithm, or the USB Device can contain software for an IPsec VPN client and can use the IPsec encryption methods to protect the data and VoIP packets between the PC and the UNC.

Embodiments can be implemented in hardware or in software, or a combination of both hardware and software. Software components can include instructions, stored on computer-readable media, such a non-volatile semiconductor memory and magnetic or optical disks. The instructions can be for execution various types of physical or virtual processors, including general purpose computers, special purpose controllers, signal processing devices, instruction interpreters and virtual machines.

Other embodiments are within the scope of the following claims.

What is claimed is:

1. An apparatus comprising:
application software stored on a computer-readable medium;
an interface for coupling the apparatus to a computer and for passing the application software to the computer; and
an authentication module for providing authentication information through the interface;
wherein the application software includes instructions for using the authentication information in a communication exchange over a data network using a cellular telephone protocol with a network element coupled to a cellular telephone network.

2. The apparatus of claim 1 embodied in a removable device for repeated coupling to the computer.

3. The apparatus of claim 1 wherein the cellular telephone protocol comprises a GSM protocol.

4. The apparatus of claim 1 wherein the network element comprises an Unlicensed Mobile Access (UMA) network controller.

5. The apparatus of claim 1 wherein the cellular telephone protocol comprises an IS-41 protocol.

6. The apparatus of claim 1 wherein the authentication module includes an interface for a Subscriber Identification Module (SIM) for accessing the authentication information.

7. The apparatus of claim 1 further comprising a secure storage for information for related to interaction with the cellular telephone network.

8. The apparatus of claim 7 wherein the secure storage includes storage for at least one of cryptographic information and cryptographic software.

9. The apparatus of claim 8 wherein the cryptographic information and software comprises at least one of the USIM, ISIM, CAVE, and IPsec information and software.

10. A method for providing telecommunication services comprising:
executing a telecommunication application on a general purpose computer; and
during execution of the communication application using authentication information at the computer in a communication exchange over a data network using a cellular telephone protocol with a network element coupled to a cellular telephone network.

11. The method of claim 10 further comprising:
loading the telecommunication application from a removable device coupled to the computer; and
accessing the authentication information from the removable device.

12. The method of claim 11 wherein accessing the authentication information from the removable device comprises accessing a Subscriber Identification Module (SIM) coupled to the removable device.

13. The method of claim 10 wherein the cellular telephone protocol comprises a GSM protocol.

14. The method of claim 10 wherein the cellular telephone protocol comprises an IS-41 protocol.

15. The method of claim 10 wherein the network element comprises an Unlicensed Mobile Access (UMA) network controller.

16. The method of claim 10 wherein using the authentication information includes accessing the authentication information from a Subscriber Identification Module (SIM).

17. The method of claim 10 wherein accessing the authentication information includes accessing a secure storage for information for related to interaction with the cellular telephone network.

18. The method of claim 17 wherein the secure storage includes storage for at least one of cryptographic information and cryptographic software.

19. The method of claim 18 wherein the cryptographic information and software comprises at least one of the USIM, ISIM, CAVE, and IPsec information and software.

20. Software stored on a computer-readable medium comprising instructions for causing a computer to:
accessing authentication information from a storage accessible to the computer; and
use the authentication information in a communication exchange over a data network using a cellular telephone protocol with a network element coupled to a cellular telephone network.
